(19) United States
(12) Patent Application Publication
(10) Pub. No.: US 2007/0168534 A1
(43) Pub. Date: Jul. 19, 2007

(54) Codec and session parameter change

(75) Inventors: Reino Juhani Hiltunen, Merimasku (FI); Jani Poikela, Helsinki (FI); Matti Takala, Helsinki (FI)

Correspondence Address: BANNER & WITCOFF, LTD., 1100 13th STREET, N.W., SUITE 1200, WASHINGTON, DC, 20005-4051, US

(73) Assignee: Nokia Corp., Espoo (FI)

(21) Appl. No.: 11/304,639

(22) Filed: Dec. 16, 2005

(51) Int. Cl. G06F 15/16

(52) U.S. Cl. 709/230

(57) ABSTRACT

Provided are apparatuses and methods for transmitting and receiving timing information corresponding to updating parameters in an Electronic Service Guide (ESG) fragment. The parameters may be associated with a session of a program or service corresponding to the ESG fragment. In one example, the parameters may be updated and a timing information such as an RTP timestamp may be provided for indicating a time when the parameters may be loaded or implemented. In this example, when the RTP timestamp is greater than or equal to a timestamp of a data packet in a data stream, the time for the parameter change may have been achieved. At this time, the new or updated parameters may be loaded at a receiver.

### FIELD OF THE INVENTION

The invention relates generally to communications networks. More specifically, the invention provides for providing updated parameters corresponding to a session of a program or service.

### BACKGROUND OF THE INVENTION

Generally, an Electronic Service Guide (ESG) enables a terminal to communicate what services are available to end users and how the services may be accessed. ESG fragments are independently existing pieces of the ESG. Traditionally, ESG fragments comprise XML documents, but more recently they have encompassed a vast array of items, such as for example, a SDP (Session Description Protocol) description, textual file, or an image. The ESG fragments describe one or several aspects of currently available (or future) service or broadcast programs. Such aspects may include for example: free text description, schedule, geographical availability, price, purchase method, genre, and supplementary information such as preview images or clips. Audio, video and other types of data comprising the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting. The ESG data may be transmitted using different types of wireless digital networks including digital broadband broadcast and/or multicast networks.

A service provider provides information on current or future services or content by transmission of corresponding ESG fragments in a data stream corresponding to an event to a subscriber terminal. However, over time, changes may be made to the event by the service provider. For example, the service provider may alter the corresponding service guide or parts thereof, change the service schedule, or promote a specific broadcast service. In addition, it may be desired to change parameters describing a session during the session rather than having static parameters that remain valid only during the availability of the corresponding service. However, the precise time of the parameter change may be unknown such that corresponding session description files may be loaded at improper times or desired content may be unexpectedly unavailable. Users or groups of users often have a need to be notified of such information or parameter changes to currently supplied information.

Thus, there exists a need for a method and system for signaling a change in parameters associated with a session or any other program or service change such as a change in the content.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a transmitter is provided for transmitting parameters corresponding to a session of a program or service. In this example, a timestamp may be included in a Session Description Protocol (SDP) file and may be transmitted to a receiver or subscriber terminal.

In another example, a receiver is provided for receiving timing information in an SDP file. The timing information may correspond to a time when a set of parameters corresponding to a session of a program or service may be valid. At this time, the set of parameters may be loaded at a receiver.

In another example, the updated or new parameters may be transported in an SDP file prior to the time indicated by the timing information in the SDP file. The SDP file may further be included in an ESG fragment.

In another example, a transmitter is provided for transmitting a data packet corresponding to a program or service and for transmitting an SDP file containing timing information for loading parameters associated with the program or service at a receiver.

In another example, a receiver is provided for receiving a data packet corresponding to a program or service and for loading updated parameters at a time indicated by a timing parameter in an SDP file received from a network.

In another example, a computer-readable medium is provided for controlling a device for receiving timing information in an SDP file and for loading updated parameters at a desired time.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a block diagram of a wireless communication system in which various aspects of the present invention may be implemented.

FIG. 2 illustrates a suitable digital broadcast receiver in which one or more illustrative embodiments of the invention may be implemented.

FIG. 3 illustrates a schematic diagram of an example of a transport object in which one or more illustrative embodiments of the invention may be implemented.

FIG. 4 illustrates examples of transporting single transport objects in which one or more illustrative embodiments of the invention may be implemented.

FIG. 5 illustrates an example of a system for creating an SDP file for signaling a time of a parameter change associated with a program or service in which one or more illustrative embodiments of the invention may be implemented.

FIG. 6 illustrates an example of a receiver or subscriber terminal receiving an ESG fragment containing an SDP file in which one or more illustrative embodiments of the invention may be implemented.

FIG. 7 illustrates an example of an SDP file for transporting parameters corresponding to a program or service in which one or more illustrative embodiments of the invention may be implemented.

FIG. 8 illustrates an example of an SDP file containing a timestamp parameter in which one or more illustrative embodiments of the invention may be implemented

FIG. 9 illustrates an example of an extension of an SDP file for describing audio parameters in which one or more illustrative embodiments of the invention may be implemented.

FIG. 10 illustrates the example of FIGS. 7, 8, and 9 in which new parameters may be sent to the receiver or subscriber terminal in the SDP file in which one or more illustrative embodiments of the invention may be implemented.

FIG. 11 illustrates an example of an updated SDP file in which one or more illustrative embodiments of the invention may be implemented.

FIG. 12 is a flowchart illustrating an example of a receiving and loading updated parameters in which one or more illustrative embodiments of the invention may be implemented.

FIG. 13 is a timing diagram illustrating an example of a receiving and loading updated parameters in which one or more illustrative embodiments of the invention may be implemented.

FIG. 14 is a timing diagram illustrating another example of a receiving and loading updated parameters in which one or more illustrative embodiments of the invention may be implemented.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

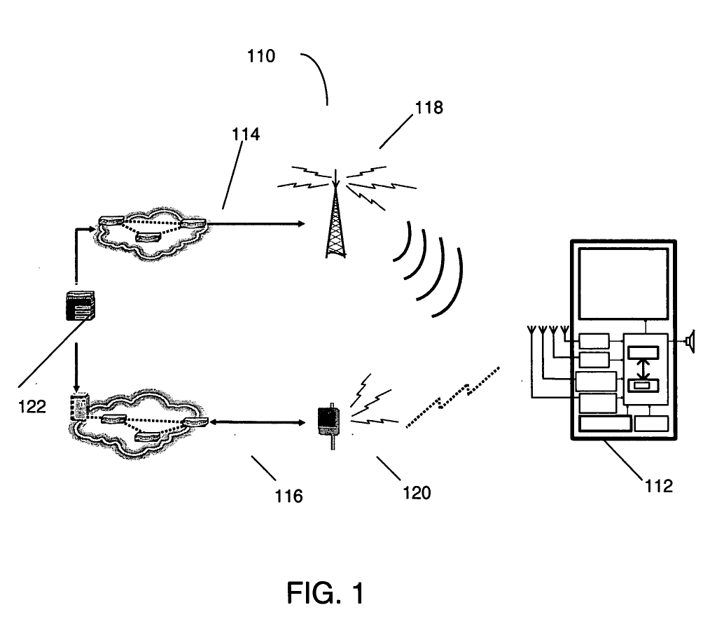

Aspects of the present invention may be utilized across a broad array of networks and communication protocols. FIG. 1 illustrates an example of a wireless communication system 110 in which the systems and methods of the invention may be employed. One or more network-enabled mobile devices 112, such as a personal digital assistant (PDA), cellular telephone, mobile terminal, personal video recorder, portable television, personal computer, digital camera, digital camcorder, portable audio device, portable radio, or combinations thereof, are in communication with a service source 122 through a broadcast network 114 and/or cellular network 116. The mobile terminal/device 112 may comprise a digital broadband broadcast receiver device. The service source 122 may be connected to several service providers that may provide their actual program content or information or description of their services and programs to the service source that further provides the content or information to the mobile device 112. The several service providers may include but are not limited to one or more television and/or digital television service providers, digital AM/FM radio service providers, SMS/MMS push service providers, Internet content or access providers.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One example used in digital video broadcasting (DVB) streams is an electronic program guide (EPG). One type of DVB is Digital video broadcasting-handheld (DVB-H), a recently developed technology that increases the capabilities and services available on small handheld devices, such as mobile telephones. The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, may be incorporated into the TS. This enables a receiver device to correctly process the data contained within the TS.

Aspects of the present invention, however, are also applicable to other digital broadband broadcast systems such as, for example, T-DAB, T/S-DMB, ISDB-T, ATSC, FLO (Forward Link Only), 3GPP MBMS, and 3GPP2BCMCS.

The exemplary broadcast network 114 may include a radio transmission of IP datacasting over DVB-H. The broadcast network 114 may broadcast a service such as a digital or analog television signal and supplemental content related to the service via transmitter 118. The broadcast network may also include a radio, television or IP datacasting broadcasting network. The broadcast network 114 may also transmit supplemental content which may include a television signal, audio and/or video streams, data streams, video files, audio files, software files, and/or video games. In the case of transmitting IP datacasting services, the service source 122 may communicate actual program content to user device 112 through the broadcast network 114 and additional information such as user right and access information for the actual program content through the cellular network 116.

The mobile device 112 may also contact the service source 122 through the cellular network 116. The cellular network 116 may comprise a wireless network and a base transceiver station transmitter 120. The cellular network may include a second/third-generation (2G/3G) cellular data communications network, a Global System for Mobile communications network (GSM), a Universal Mobile Telecommunications System (UMTS) or other wireless communication network such as a WLAN network.

In one aspect of the invention, mobile device 112 may comprise a wireless interface configured to send and/or receive digital wireless communications within cellular network 116. The information received by mobile device 112 through the cellular network 116 or broadcast network 114 may include user selection, applications, services, electronic images, audio clips, video clips, and/or WTAI (Wireless Telephony Application Interface) messages. As part of cellular network 116, one or more base stations (not shown) may support digital communications with receiver device 112 while the receiver device is located within the administrative domain of cellular network 116.

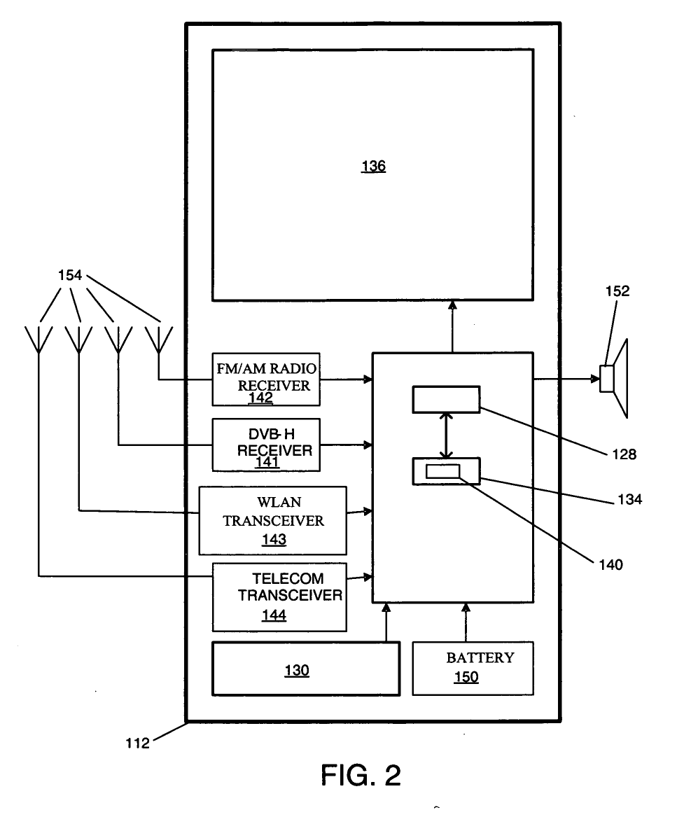

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H, DVB-T or DVB-MHP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), DVB-Terrestrial (DVB-T) or DVB-Cable (DVB-C). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting-Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing consists of sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

In one example of the present invention, ESG fragments may be delivered to a subscriber terminal in one or more data streams or channels. In this example, a plurality of channels (such as IP-packet streams) can be used to deliver ESG information to the subscriber terminal. For example, the ESG fragment may provide the subscriber terminal with notification of upcoming events to be provided by a service provider, changes in current events provided by a service provider or updated or on-going information for a user or group of users.

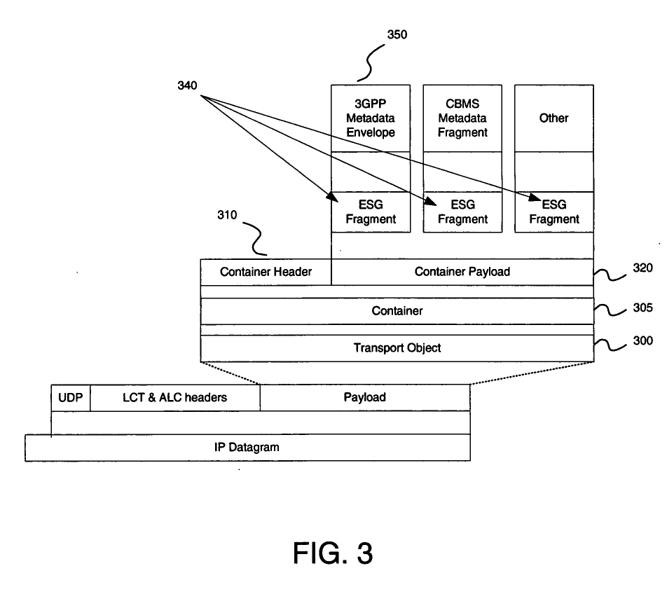

ESG fragments may be delivered in a transport object which may transport ESG information in a container. Thus, ESG fragments may be placed in a container that may be delivered in its own transport object. The container may further include a container header and a container payload, for example, in which the container header may provide information on where each container is located within the transport object. In one example, the transport object may contain a single container or a plurality of containers, each container including at least one ESG fragment. FIG. 3 is a diagram of an example transport object in accordance with at least one aspect of the present invention. As illustrated in the example of FIG. 3, a transport object 300 may comprise a container that may include a container header 310 and a container payload 320. In one example, the container header 310 and the container payload 320 are incorporated into a single container 305 which may be incorporated into a single transport object 300 so that the container header 310 need not be recombined with information regarding where each container is located within different transported objects. Alternatively, the transport object 300 may contain a plurality of containers and a container may contain any number of ESG fragments 340. The container header 310 may contain information associated with a corresponding ESG fragment such as, for example, information regarding the container header 310 itself and/or the container payload 320.

In the example illustrated in FIG. 3, the ESG fragment 340 is contained in the container payload 320. The container header 310 may contain descriptors for identifying and describing ESG fragments in the corresponding container payload 320. Thus, the characteristics of the ESG fragment may be identified, such as but not limited to the position of the ESG fragment in the transport object 300 or the length of each contained ESG fragment 340. For example, in one embodiment, a field specifies where the particular ESG begins within the container payload 320 by providing, for example, an offset value, start and end points, or the like. In other embodiments, metadata 350 may be associated with the individual ESG fragments 340, located within or proximate to the header 310, descriptor entries, an ESG fragment 340 or a mixture thereof. In one exemplary embodiment, the association of a 3GPP metadata envelope with an ESG fragment 340 may substitute for, or negate the need of additional metadata to be located in the header 310 in relation to that particular ESG fragment.

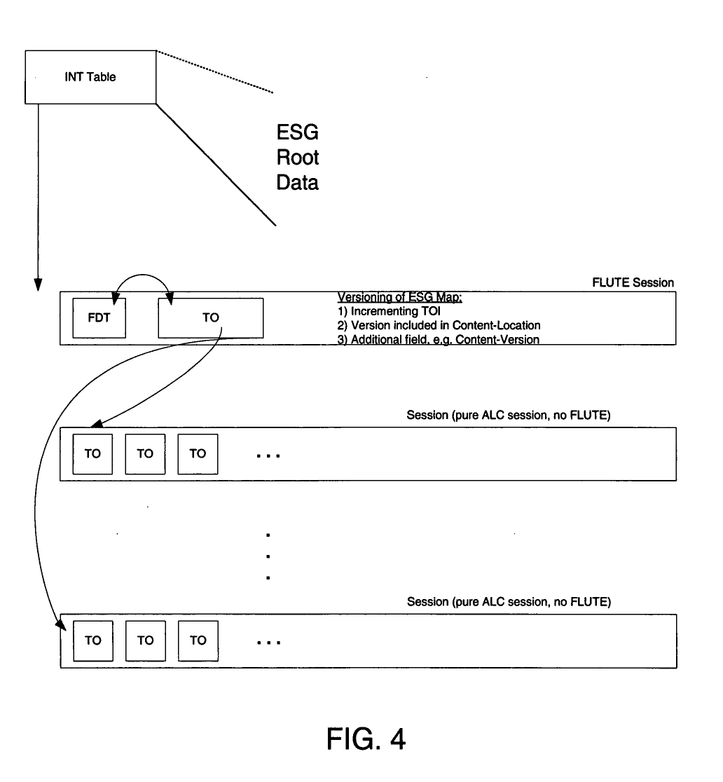

FIG. 4 illustrates an example of transmitting a plurality of single Transport Objects. As illustrated in FIG. 4, the Transport Objects (TO) of the current invention may be carried in, for example, FLUTE (File Delivery over Unidirectional Transport) sessions, or a pure Asynchronous Layered Coding (ALC) session. In the example of FIG. 4, the ESG Root Channel data, such as IP Address, port number and Transport Session Identifier (TSI), are announced in the IP/MAC Notification Table (INT Table) which may be, for example, carried in the SI/PSI stream in DVB-H as one of the SI tables of DVB-H. The FLUTE session of the ESG Root Channel comprises a File Delivery Table (FDT) of the session and one or more Transport Objects (TO). These Transport Objects that may be delivered in announcement carousels contain mapping between the different parts of ESGs and access parameters to the different ESG methods in which the ESG data is transmitted. The ESGs may differ from each other. For example, ESGs may be in different languages, genres or encoding.

Examples of access parameters may include, for example, IP Addresses, port numbers, TSIs, start and end times etc. The FLUTE session thus declares how the ESG data is distributed to different sessions. The TOs of the FLUTE session carrying this mapping data are described in the FDT of the FLUTE session. The ESG mapping data may be delivered in one or multiple TOs. The mapping can be made using XML Schema, plain ASCII text, Structured ASCII text such as multipart MIME or MIME headers, as binary with enumerated types or through various other means as is known in the art. The ESG data is in this example may be delivered in one or more TOs, which may be within pure ALC sessions, for example. The ESG data or parts of it may be delivered in some embodiments of the invention in one or more FLUTE sessions in addition to or instead of ALC sessions.

The ESG may further contain a timestamp associated with a transmitted or received data stream. A Real-Time Protocol (RTP) timestamp is one such example of a timestamp. The timestamp may, for example, may indicate a time in which data may be presented or utilized. For example, an audio or video data stream may contain a timestamp representing the time that the data may be played. The time of presentation or display of the data associated with the timestamp may further be presented with respect to previously received data packets.

A transmitted data stream may further contain parameters for describing the session. An example of such parameters includes session and/or decoding parameters that describe the corresponding session. These parameters may further be transmitted to receivers within SDP files which may, in turn, be grouped with other files within the ESG fragment. SDP files may be transmitted to a receiver in a variety of ways. For example, one way of transmitting SDP files is in a burst that is separate from the data stream. In this example, a time-slice for each service may be created that transports the parameters (e.g., service parameters) in an SDP file. The time-slice that transports the parameters may be separate but close to a burst or time-slice corresponding to the service. Thus, a receiver may receive the burst containing the parameters in an SDP file associated with a service in advance of receiving the separate time-slice burst transporting the service.

In another example of transmitting an SDP file, the SDP file may be included in the same burst as the session. In this example, the SDP file may be included, for example, at the beginning of the time-slice burst for the service. In this way, a receiver or subscriber station receiving the service may receive the corresponding SDP file (and corresponding parameters) at approximately the same time as the service.

The SDP file and corresponding parameters may be transmitted in an ESG fragment. The parameters in the SDP file may describe characteristics of the corresponding program or service including, for example, session name, purpose, time, type of media, format, transport protocol, port number, bandwidth requirements, etc. However, it may be difficult to effectively update parameters if changes or updates to the parameters are necessary. This may be particular problematic in the event of schedule changes because the exact moment of the parameter changes may not be known. Hence, because the precise time of the parameter (or program or service content) change might not be known, the corresponding program or service may become loaded at the wrong time or a receiver or subscriber terminal may be unable to play the program or service content.

In one example of the present invention, a time of a desired parameter change associated with a transmitted program or service may be signaled in advance of the time the change is to be implemented. In this example, the time of a parameter change is signaled in a timestamp (e.g., RTP timestamps) of a media stream. The timestamp may be included, for example, in an SDP file which may be within an ESG fragment.

The SDP file may thus provide session and parameter information as well as timing information corresponding to the program or service. As one example of an SDP file for providing such information, the SDP file may contain a parameter or information corresponding to an origin of the session which may include, for example, a name, a session identifier, an indication of a version of the session, an address of the origin, etc. The SDP file may also contain a parameter or identifier for a location of any information of interest. For example, the SDP file may contain a reference to a web page associated with the program or service. The SDP file may also contain a reference to an ESG fragment associated with the program or service.

The SDP file may also contain other parameters or identifiers such as a destination address or a start time for a program or service. In this example, the corresponding program or service may become available after the indicated start time but may not be available prior to the indicated start time. The SDP file may also contain media-specific parameters.

In an example of the present invention, the SDP file may further contain a parameter for a timestamp. For example, a parameter may be provided in the SDP file for indicating a time in which parameters are changed. The timestamp may be transmitted to a receiver as soon as a decision on the timestamp has been made and in advance of the parameter change time. Thus, in this example, when the exact time for the parameter change arrives, the new or changed parameters may be set as described herein.

Likewise, an ESG fragment containing a parameter for a timestamp may be received at a receiver or subscriber terminal. The parameter may be contained in an SDP file within the ESG fragment. In this example, after a data packet is received at the receiver or subscriber terminal, the timestamp in the ESG fragment may indicate a time that the corresponding program or service may be provided or played. The corresponding program or service may be associated with new (or changed) parameters which may be changed at the start time of the program or service. In this example, the ESG fragment contains a timestamp that signals the parameter change in advance of the time of the parameter change. Hence, even if the exact time of the parameter change is not known, the receiver or subscriber terminal may receive the parameter change information in advance. Also, the receiver or subscriber terminal may have internal delays such as buffering delays which may affect the precise time of the parameter change. In this example, the parameter change is signaled in advance such that the new or changed parameters may be loaded at the proper time.

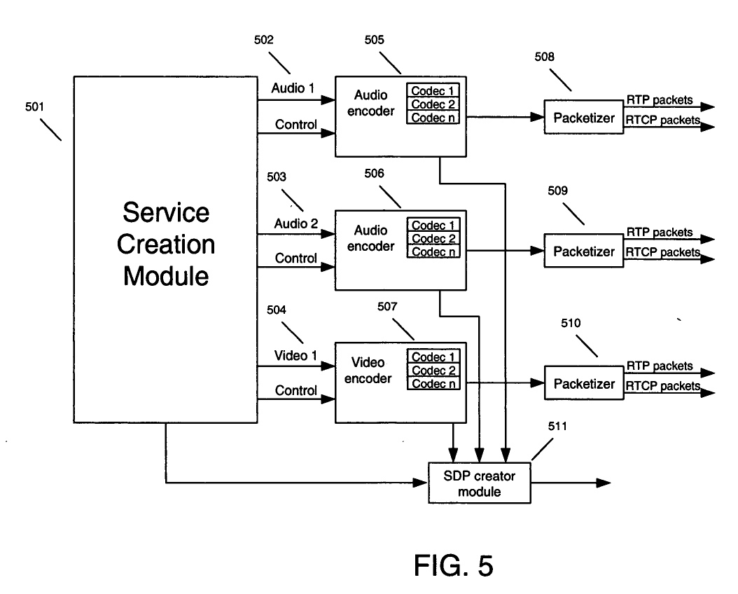

FIG. 5 illustrates an example of a system for creating an SDP file for signaling a time of a parameter change associated with a program or service. In this example, a service is created in the service creation module 501. The service may be created with associated parameters for describing the corresponding session. In this example, the service created may have multiple components including a video component and an audio component. As illustrated in the example of FIG. 5, the service may include multiple audio components or multiple video components. In this example, two audio components (502, 503) are provided in the service and one video component is provided (504). Each of the audio components are encoded in an audio encoder (505, 506) and the video component is encoded in a video encoder (507). Data packets corresponding to the service or media stream may be packetized in packetizers (508, 509, 510). There are many types of encoding that may be implemented. For example, if the original audio is in analog format, a digital encoding (e.g., Advanced Audio Coding (AAC), Adaptive Multi-Rate Wide-Band (AMR-WB) and/or MP3 (MPEG-2, layer 3)). Digitally encoded audio may be transcoded with different codecs and parameters. The resulting audion may have codec and parameters suitable for the terminals. In another example, a video signal is provided and the encoding may include, for example, H.264 or Moving Pictures Expert Group 4 (MPEG4), Advanced Video Coding (AVC) or VC-1, to name a few. The resulting data packets may be transmitted to a receiver or subscriber terminal.

Also, the service may have associated session information. As one example of session information, the service may have a corresponding expected duration of usage. Any description of the session associated with the service may be described as one or more parameters which may be included in a corresponding SDP file. An SDP file corresponding to the service may be created at the SDP creator module 511. The SDP creator module may receive the corresponding parameters from the service creation module 501 and may incorporate the parameters in an SDP file. The SDP creator module 511 may send the SDP file to a receiver or subscriber terminal. The SDP file may be incorporated in an ESG fragment. As set forth above, the SDP file may be transmitted in the same burst as program or service information or may be transmitted in a separate burst.

The time when the new parameters are to be used in this example is added to the SDP file. The SDP file thus created may be sent to a receiver or subscriber terminal. At the indicated time, the parameters may be updated or changed accordingly. The parameters may be changed and sent to the SDP creator module 511 from the encoders (505, 506, 507). Also, a corresponding timestamp may be sent to the SDP creator module 511 at the time of the parameter change.

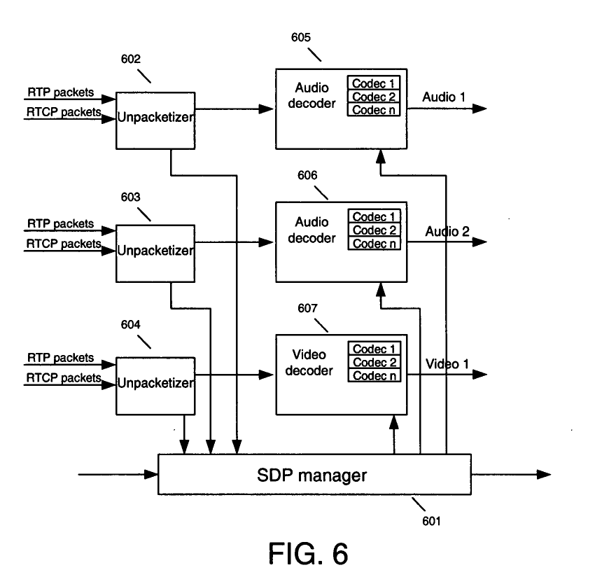

FIG. 6 illustrates an example of a receiver or subscriber terminal receiving an ESG fragment containing an SDP file. In this example, the SDP file received at the receiver or subscriber terminal may contain parameters associated with a program or service. The program or service may be associated with parameters that may change based on various factors such as but not limited to duration of the session or time of start of a session. In this example, the ESG fragment is received and the SDP information is detected at the SDP manager module 601. Also, data packets associated with the program or service may be received at an unpacketizer (602, 603, 604) which may transmit the data packets to decoders (605, 606, 607). The decoders (605, 606, 607) may further receive parameters from the SDP manager module 601. The received parameters may describe a corresponding program or service. Also, a timestamp and/or buffering information may be received at the SDP manager module 601 from the unpacketizers (602, 603, 604).

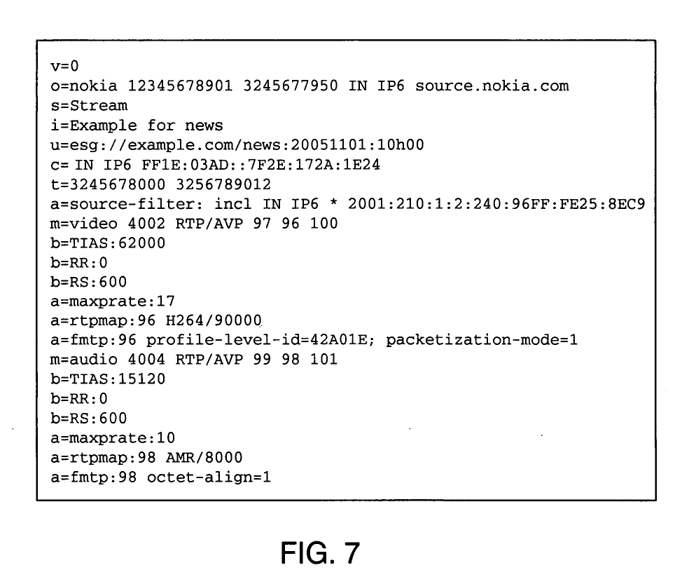

In one example of the present invention, session and parameter information and timing information for describing a precise time for a parameter change associated with a program or service is provided in an SDP file. FIG. 7 illustrates an example of an SDP file for transporting parameters corresponding to a program or service. In this example, the SDP file may contain different fields or lines for providing desired information. For example, a typical SDP file may contain an “o” line for providing an origin of the session for the program or service. This line may include a name, a session ID, a version and an address of the origin as illustrated in the example of FIG. 7. In addition, the SDP file may contain a “u” line for providing an identifier or a location of additional information. This may include, for example, a reference to a web page or ESG fragment associated with or describing the program or service. The SDP file may further contain a “c” line for providing a destination address. This destination address may describe the location where the data stream is to be delivered. A “t” line may also be provided for providing traditional coarse timing information. This traditional coarse timing information may be a decimal representation of Network Time Protocol (NTP) and may provide a time at which a session may be available. This field may provide timing information to an accuracy of one second.

The SDP file as illustrated in FIG. 7 may also include an “m” line which may provide any media-specific parameters associated with the program or service. The media-specific parameters provided in the SDP file may be multiple and may continue from an “m” line to the end of the SDP file or may continue to a subsequent “m” line. Media-specific parameters may include any parameters for describing characteristics of the program or service. This may include, for example, parameters for indicating audio encoding, video encoding, etc. Examples of media-specific parameters include IP address and port, encoding (codec), sampling frequency, bit rate, mode (e.g., mono, stereo, etc), to name a few.

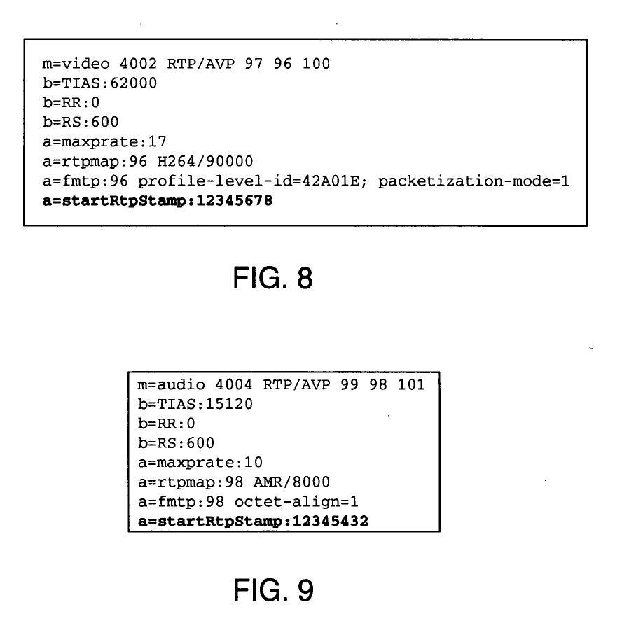

As illustrated in the example of FIG. 8, a timestamp parameter is provided in the SDP file. The timestamp in this example is an RTP timestamp for providing an exact start time of the corresponding program or service. In the example illustrated in FIG. 8, the RTP timestamp is named startRtpStamp and is provided with an exemplary value of 12345678. In this example, an extended SDP file is illustrated including a description of video parameters including a startRtpStamp RTP timestamp.

FIG. 9 illustrates an example of an extension of an SDP file for describing audio parameters including a startRtpStamp exemplary timestamp. In the examples illustrated in FIGS. 7, 8, and 9, an SDP file with the timestamp parameters as described (e.g., a video timestamp parameter of 12345678 and an audio timestamp parameter of 12345432), a receiver or subscriber terminal receiving the SDP file may utilize the coarse timing parameter “t” as an approximation of the time of commencement of the program or service.

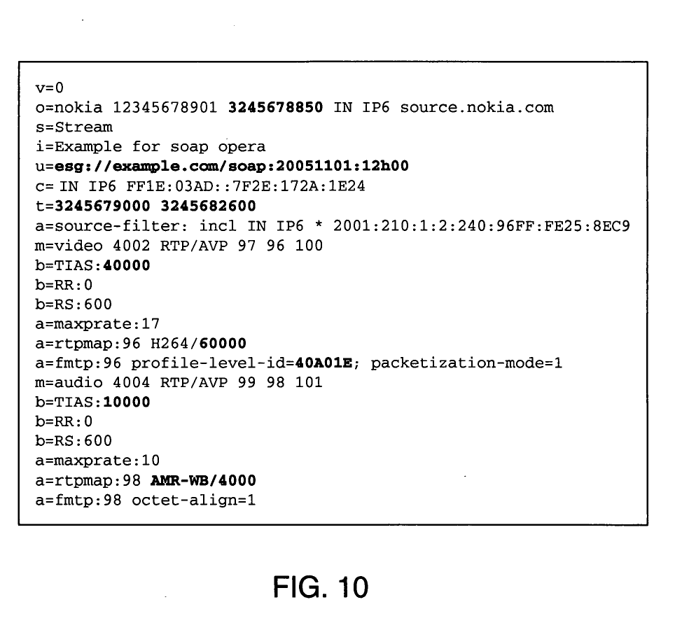

FIG. 10 illustrates the example of FIGS. 7, 8, and 9 in which new parameters may be sent to the receiver or subscriber terminal in the SDP file. In this example, a new session version is indicated. The new session version data may indicate that the SDP contains new information. In this example, the SDP file contains new information including new information in the “u” line for indicating an address for additional information corresponding to the ESG fragment. Also, the “t” line (i.e., coarse timing information) has been updated in this example as will as various media-specific parameters.

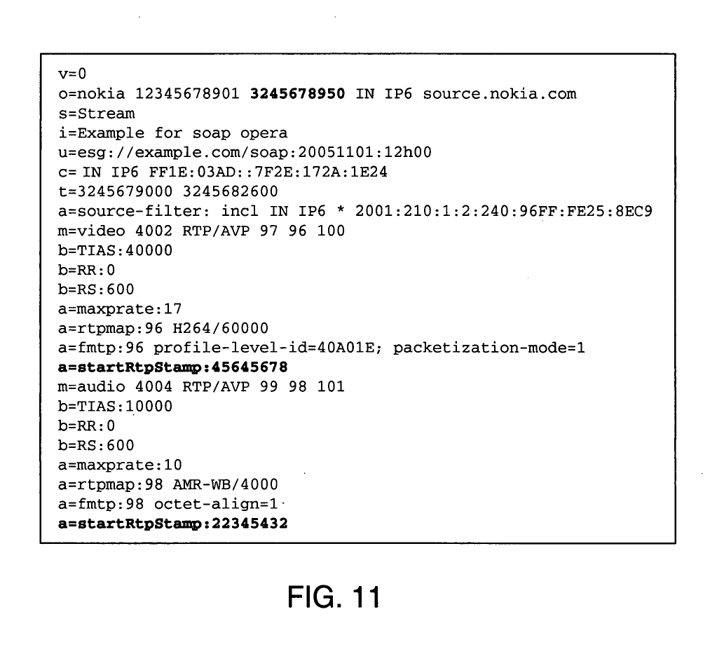

After an exact time for a parameter change is known, an updated SDP file may be provided. FIG. 11 illustrates an example of an updated SDP file after the exact time stamp of a parameter change is known. In this example, the session version is updated as well as the timestamp parameter.

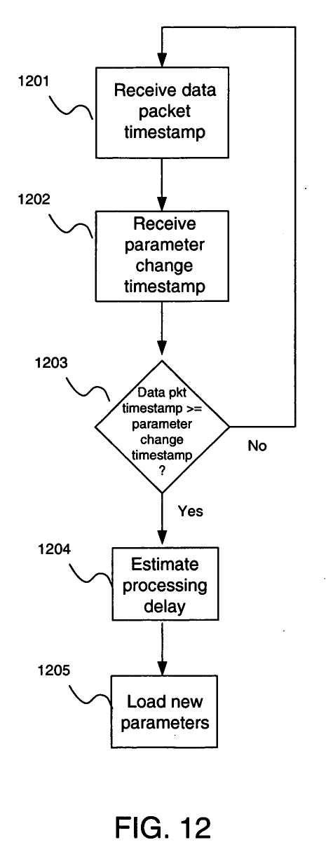

FIG. 12 illustrates another example of one aspect of the invention. In this example, a timestamp is included in an ESG fragment for providing a time at which a parameter describing a program or service in an ESG fragment may change or may be updated. The timestamp may be included in an SDP file within an ESG fragment. As illustrated in FIG. 12, a receiver or a subscriber terminal may receive a data packet containing a timestamp (STEP 1201). The receiver may also receive a timestamp in an SDP file in an ESG fragment signaling a time for a change in parameters associated with the corresponding program or service (STEP 1202). The receiver may compare the timestamp in the data packet to the timestamp received in the SDP file indicating a time for a parameter change (STEP 1203). If the timestamp in the data packet is less than the timestamp in the SDP file indicating a time for a parameter change (“NO” branch of STEP 1203), then the receiver may wait as the timestamp in subsequent data packets may increase. If the timestamp in the data packet is greater than or equal to the timestamp in the SDP file indicating a time for a parameter change (“YES” branch of STEP 1203), then the time for the parameter change has been reached and the new parameters may be loaded (STEP 1205). Additionally, the receiver may estimate a processing delay (STEP 1204) and wait the proper amount of time prior to loading the new parameters. One example of a processing delay may include a buffering delay.

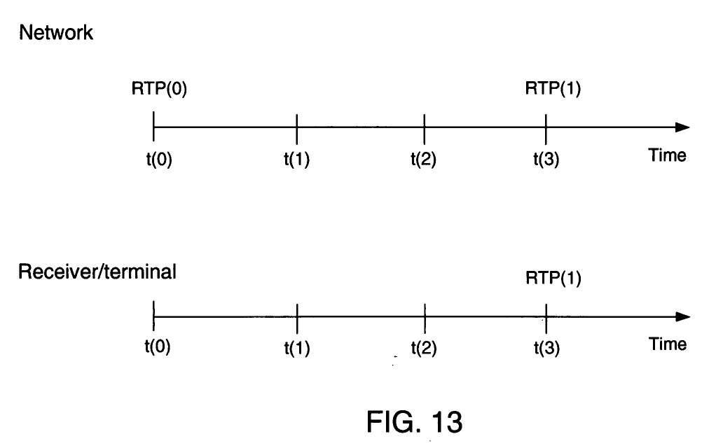

FIG. 13 is a timing diagram illustrating another example. In this example, an encoder produces a data stream at time t(0). The initial data stream may include an ESG fragment containing parameters describing the session. The parameters may be within an SDP file in the ESG fragment. The parameters have initial values and may include a timestamp parameter, RTP(0) as illustrated. The data stream may be transmitted to a receiver or subscriber terminal as illustrated in FIG. 13. In this example, the receiver/terminal receives the data stream with the initial parameters at time t(0) when the data stream is transmitted in the network. As described above, the data stream may contain the timestamp parameter (e.g., RTP(0)).

At time t(1), which is later than time t(0), a change in parameters in the SDP file or ESG fragment may be desired at some time. In this example, the new parameters may be determined but the time of implementation of the new parameters may not have been decided. For example, an exact time of a new program or an end of a current program or service may not have yet been determined at time t(1) so that the time for implementation of the corresponding new parameter is not known at time t(1). Examples of new parameters include, for example, schedule information or validity information. Hence, in this example, the receiver/terminal receives the new parameters beginning at time t(1) via the network. However, at time t(1), the time for implementation of the new parameters is not yet known so the receiver/terminal does not load the new parameters at this time. Rather, the receiver/terminal loads the current parameters which are currently valid. The new parameters or future parameters may be available but may not be designated as valid at this time.

At time t(2) in this example (later than time t(1)), the precise time for the parameter change is determined and the parameters in the SDP file or ESG fragment may be updated accordingly. In this example, the timestamp parameter in the SDP file in the ESG fragment may be updated to indicate the time for the parameter change. The timestamp parameter is updated at time t(2) and sent to the receiver/terminal. In this example, the time for the parameter change is time t(3) which is after time t(2). Hence, the data stream received at the receiver/terminal at time t(2) contains a timestamp parameter indicating time t(3) as the time for the parameter change. At this time, the receiver/terminal continues to load the current parameters because the time for the parameter change (i.e., time t(3) in this example) has not yet occurred.

Thus, as described, the receiver/terminal receives the ESG fragment and SDP in this example containing the timestamp parameter indicating the exact time for the parameter change (e.g., RTP(1) in this example) at time t(2). Also at this time, the receiver/terminal receives the new parameters with the timestamp RTP(1) indicating the precise time for implementation of the new parameters. Thus, the time for the parameter change in the ESG fragment is indicated by the timestamp parameter in the SDP file in the ESG fragment as RTP(1) in this example. The new parameters may be implemented at time t(3) at the receiver/terminal based on the timestamp RTP(1) received in the ESG fragment. For example, when the timestamp in a received data packet is greater than or equal to the timestamp RTP(1) received in the ESG fragment (i.e., t(3) is reached), the new parameters are set to the encoders and the receiver/terminal sets the new parameters in the decoder.

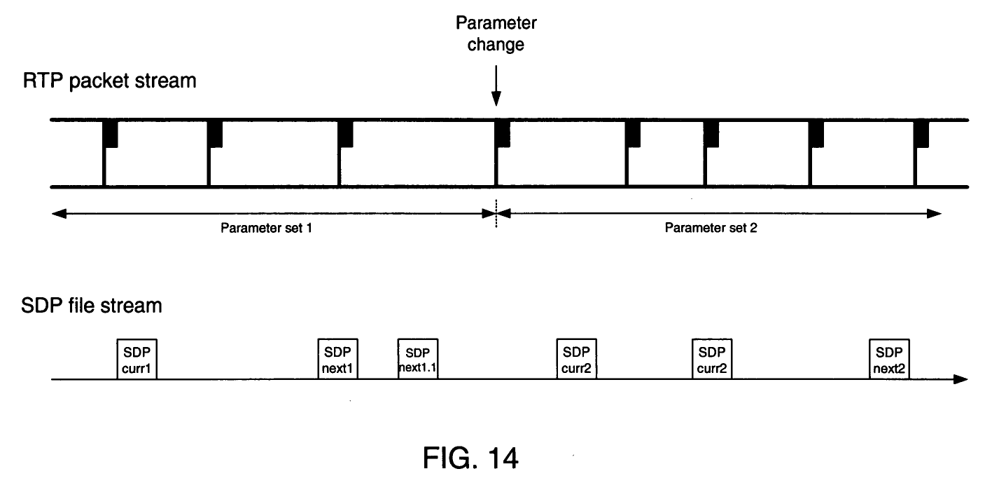

FIG. 14 illustrates timing diagrams of another example. In this example, data or RTP packets are transmitted from a transmitter to a receiver or subscriber terminal. Each of the RTP packets contains an RTP timestamp for indicating a time of the RTP packet. In addition, SDP files are transmitted to the receiver/terminal. As FIG. 14 illustrates in this example, the SDP file, SDP curr1, is transmitted to the receiver/terminal and contains parameter set 1 for describing a corresponding session. The parameters in SDP curr1 are valid for the current RTP packet stream. In this example, each of the RTP timestamps in the RTP packet stream is compared to the timestamp parameter in SDP curr1. At this time, the timestamp parameter in SDP curr1 is less than the timestamp in the RTP packet stream.

SDP next1 represents an SDP file transmitted when a parameter change is determined to occur. SDP next1 is transmitted prior to the time that the parameter change is to occur as illustrated in FIG. 14, however, the precise time of the parameter change may not be known at this time. SDP next1 may also contain the new parameter set (i.e., parameter set 2 in this example) and coarse timing information for providing an approximate time of the parameter change. At a subsequent time, the precise time of the parameter change may be determined. In this example, after the precise time of the parameter change is determined, SDP next1.1 is transmitted that contains the exact time information. For example, SDP next1.1 may contain an updated timestamp parameter for indicating the precise time of the parameter change. Any number of updates to the time for parameter change may be made. For example, additional SDP files subsequent to SDP next1.1 may be transmitted with additionally updated timestamp information as the precise time of the parameter change may be changed. Alternatively, the precise time of the parameter change may be known initially and the updated RTP timestamp indicating the precise time may be included in the SDP nextl SDP file.

At the time of the parameter change, the timestamp in the RTP packet stream may be compared to the timestamp parameter in the SDP file (in this example, SDP next1.1). The timestamp in the RTP packet stream being less than or equal to the timestamp parameter in the SDP file may indicate to the receiver/terminal that the time for the parameter change has been reached. At this time, the receiver/terminal may be informed from the timestamp information which parameter set is current. Because the time of the parameter change has been reached, parameter set 2 is now the current parameter set in the present example. In another example, there may be different versions of the parameters and the different versions of parameter sets may overlap in time. There are many ways of determining the proper parameter set when different versions exist. For example, a version number may be associated with SDP files or parameter sets in SDP files. In one example, the highest version number indicates the current parameter set. Alternatively, additional information may indicate the current parameter set such as information corresponding to an ESG fragment.

In the present example illustrated in FIG. 14, the new parameter set (parameter set 2) is loaded after the time of the parameter change. Hence, SDP curr2 contains the new parameter set 2. If a subsequent parameter change is desired, SDP next2 may be transmitted that may contain the exact time for the second parameter change. SDP next2 may further include coarse timing information for indicating an approximate time for the parameter change. When the precise time for the parameter change is known, the timestamp parameter may be updated in the SDP file and SDP next2 may be transmitted. In this example, SDP next2 may include the next set of parameters. When the time for the second parameter change is reached (e.g., based on comparison of the timestamps in the RTP packet stream with the timestamp parameters in the SDP files), the next parameter set may be implemented.

The present invention includes any novel feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

We claim:

1. A method for transmitting parameters for describing a session of a program or service, the method comprising:
receiving a timestamp corresponding to a time for updating a parameter corresponding to the program or service;
inserting the timestamp in a Session Description Protocol (SDP) file;
transmitting the SDP file.

2. The method of claim 1 wherein transmitting the SDP file comprises transmitting the SDP file in an Electronic Service Guide (ESG) fragment.

3. The method of claim 1 wherein the timestamp is a Real-Time Protocol (RTP) timestamp.

4. The method of claim 1 wherein the timestamp corresponds to a precise time for updating the parameter.

5. A method for changing a first set of parameters corresponding to a session of a program or service to a second set of parameters, the method comprising:
receiving a data packet corresponding to the program or service, the data packet including a time of the data packet;
receiving a Session Description Protocol (SDP) file, the SDP file comprising a first timing information corresponding to a time for changing the first set of parameters; and
changing the first set of parameters based on the first timing information and the time of the data packet.

6. The method of claim 5 wherein the changing comprises comparing the first timing information to the time of the data packet and updating the first set of parameters based on the comparing.

7. The method of claim 6 wherein the SDP file comprises the second set of parameters.

8. The method of claim 7 wherein the updating comprises loading the second set of parameters if the first timing information is greater than or equal to the time of the data packet.

9. The method of claim 5 further comprising estimating a processing delay wherein the changing step includes updating the first set of parameters after the processing delay has elapsed.

10. The method of claim 5 wherein the SDP file comprises the second set of parameters and the step of changing comprises loading the second set of parameters at a receiver.

11. The method of claim 5 wherein the first set of parameters comprises at least one of an origin of a session, a name of a session, a version, an address, an identifier, a location of additional information, a destination address, coarse timing, schedule information, validity information, or a media-specific parameter.

12. The method of claim 5 wherein the time of the data packet comprises a Real-Time Protocol (RTP) timestamp.

13. The method of claim 5 wherein the SDP file comprises the first set of parameters and the step of receiving the SDP file comprises receiving the SDP file at a current time, the current time being prior to a time corresponding to the first timing information.

14. The method of claim 13 wherein the SDP file comprises the second set of parameters prior to the time corresponding to the first timing information, the second set of parameters corresponding to the changed first set of parameters.

15. The method of claim 13 further comprising receiving the second set of parameters at the current time.

16. The method of claim 13 wherein the SDP file comprises the second set of parameters after the current time.

17. The method of claim 14 further comprising loading the second set of parameters at a receiver at or after the time corresponding to the first timing information.

18. A transmitter for transmitting parameters for describing a session of a program or service comprising:
an Session Description Protocol (SDP) module for creating an SDP file;
an encoder for transmitting a data packet corresponding to the program or service,
wherein the SDP file comprises a first set of parameters at a first time and a second set of parameters and a time parameter at a second time, the second time being subsequent to the first time, wherein the time parameter indicates when the second set of parameters are valid.

19. The transmitter of claim 18 wherein the time parameter indicates a third time corresponding to when the second set of parameters are valid, the third time being subsequent to the second time.

20. The transmitter of claim 19 wherein the SDP file comprises the second set of parameters between the second time and the third time.

21. A receiver for receiving parameters corresponding to a session of a program or service comprising:
an SDP manager for receiving an SDP file, the SDP file comprising a first set of parameters corresponding to the session of the program or service and a time parameter;
a decoder for decoding a data packet corresponding to the program or service, the data packet comprising a timestamp,
wherein the SDP manager loads the first set of parameters into the decoder when the time parameter is greater than or equal to the timestamp.

22. The receiver of claim 21 wherein the SDP manager loads the first set of parameters into the decoder after a delayed period of time after the timestamp.

23. The receiver of claim 22 wherein the period of time corresponds to a buffering delay.

24. The receiver of claim 21 wherein the SDP manager receives the timestamp from the decoder and compares the timestamp to the time parameter received in the SDP file.

25. The receiver of claim 21 wherein the timestamp comprises a Real Time Protocol (RTP) timestamp.

26. The receiver of claim 21 wherein the SDP file comprises the first set of parameters at a first time, the first time corresponding to the time indicated by the timestamp and being less than the time indicated by the time parameter.

27. The receiver of claim 26 wherein the SDP file comprises the time parameter at the first time.

28. A computer-readable medium having computer-readable instructions that when executed perform the steps of:
receiving a data packet corresponding to a program or service at a receiver, the data packet including a time of the data packet;
receiving a Session Description Protocol (SDP) file, the SDP file comprising a first set of parameters and a first timing information corresponding to a time for loading the first set of parameters at a receiver; and
loading the first set of parameters at the receiver based on the first timing information and the time of the data packet.

29. The computer-readable medium of claim 28 wherein the first set of parameters is loaded at the receiver when the time of the data packet is greater than or equal to the first timing information.

30. The computer-readable medium of claim 29 wherein the SDP file comprises the first set of parameters prior to a time corresponding to the timing information.
